(19) United States
(12) Patent Application Publication
(10) Pub. No.: US 2007/0206960 A1
(43) Pub. Date: Sep. 6, 2007

(54) Transmission Formats for High Bit-Rate Systems

(75) Inventors: Morten Nissov, Ocean, NJ (US); Alexei N. Pilipetskii, Colts Neck, NJ (US); Jin-Xing Cai, Morganville, NJ (US); Neal S. Bergano, Lincroft, NJ (US)

Correspondence Address: GROSSMAN, TUCKER, PERREAULT & PFLEGER, PLLC, 55 SOUTH COMMERICAL STREET, MANCHESTER, NH, 03101, US

(73) Assignee: TYCO TELECOMMUNICATIONS (US) INC., Morristown, NJ (US)

(21) Appl. No.: 11/682,511

(22) Filed: Mar. 6, 2007

Related U.S. Application Data
(60) Provisional application No. 60/779,700, filed on Mar. 6, 2006.

(51) Int. Cl. H04B 10/04

(52) U.S. Cl. 398/188

(57) ABSTRACT

An apparatus, system and method wherein a multi-level data modulation format, such as DQPSK, is combined with symbol rate synchronous amplitude, phase, and/or polarization modulation.

### CROSS-REFERENCE TO RELATED APPLICATIONS

The present application claims the benefit of the filing date of U.S. Provisional Application Ser. No. 60/779,700, filed Mar. 6, 2006, the teachings of which are hereby incorporated herein by reference.

### TECHNICAL FIELD

The present application relates to the optical transmission of information and more particularly, to improving the transmission capabilities over optical fiber transmission systems.

### BACKGROUND

Very long optical fiber transmission paths, such as those employed in undersea or transcontinental terrestrial lightwave transmission systems that employ optical amplifier repeaters, are subject to decreased performance due to a host of impairments that accumulate along the length of the optical fiber of the transmission path. The source of these impairments within a single data channel may include amplified spontaneous emission (ASE) noise generated in the Erbium-Doped Fiber-Amplifiers (EDFAs), nonlinear effects caused by dependence of the single-mode fiber's index on the intensity of the light propagating through it and chromatic dispersion which causes different optical frequencies to travel at different group velocities. Also, polarization dependent effects may lead to time-varying impairments such as polarization mode dispersion which causes different polarizations to travel with different group delays and/or polarization dependent loss which causes different polarizations to have different attenuations. In addition, for wavelength division multiplexed (WDM) systems where several optical channels might be on the same fiber, crosstalk between channels caused by the fiber's nonlinear index may be a concern.

In some systems it may be advantageous to operate long-haul transmission systems at high data rate per channel. Multiples of the Synchronous Digital Hierarchy (SDH) standard, for example 10 Gb/s and 40 Gb/s, may be considered useful. Generally speaking, the impairments that limit the system's performance may cause two types of degradations in the received eye pattern related to randomness (caused by noise) and deterministic degradations (or distortions in the received bit pattern). Distortions of the second type are sometimes refereed to as Inter-Symbol Interference or ISI. As the bit rates rise into the tens of gigabit per second range it may be useful to manage those impairments that affect the shape of the received pulses, and to limit the ISI.

Distortions of the received waveform are influenced by design of the transmission line, as well as the shape of the transmitted pulses. Known long-haul systems have been implemented using On-Off-Keying (OOK), wherein the transmitted pulse is turned on and off with the ones and zeros of a data bit stream. On-Off-Keying may be implemented in a variety of well-known formats, such as Return-to-Zero (RZ), Non-Return to Zero (NRZ) and Chirped-Return-to-Zero (CRZ) formats. Generally, in a RZ format the transmitted optical pulses do not occupy the entire bit period and return to zero between adjacent bits, whereas in a NRZ format the optical pulses have a constant value characteristic when consecutive binary ones are sent. In a chirped format, such as CRZ, a bit synchronous sinusoidal phase modulation is imparted to the transmitted pulses.

Phase Shift Keying (PSK) is another modulation method known to those of ordinary skill in the art. In PSK modulation ones and zeros are identified by phase differences or transitions in the optical carrier. PSK may be implemented by turning the transmitter on with a first phase to indicate a one and then with a second phase to indicate a zero. In a differential phase-shift-keying (DPSK) format, the optical intensity of the signal may be held constant, while ones and zeros are indicated by differential phase transitions. DPSK modulation formats include RZ-DPSK, wherein a return-to-zero amplitude modulation is imparted to a DPSK signal, and CRZ-DPSK.

Multi-level modulation formats have also been of interest. In a multi-level modulation format multiple data bits may be encoded on a single transmitted symbol. These formats may enhance spectral efficiency and improve tolerances to the above-referenced impairments. A number of multiple-level modulation formats are known. Examples of multi-level modulation formats useful for encoding two-bits per symbol include: quadrature phase shift keying (QPSK); differential quadrature phase shift keying (DQPSK) wherein information is encoded in four differential phases; and a combination of amplitude shift keying and differential binary phase shift keying (ASK-DBPSK). Multi-level modulation fomats with eight symbol levels useful for encoding three bits per symbol include differential 8-level phase shift keying (D8PSK) and ASK-DQPSK. A combination of quadrature amplitude shift keying and differential quadrature phase modulation (QASK-DQPSK) may be used to provide 16 symbol levels, or four bits per symbol.

When the bit rate of a transmission system is increased the transmission penalties may become more pronounced. In view of the impairments listed above, it may be difficult using conventional techniques to transmit a 40 Gb/s signal across transoceanic distances with adequate performance margin.

### BRIEF DESCRIPTION OF THE DRAWINGS

Reference should be made to the following detailed description which should be read in conjunction with the following figures, wherein like numerals represent like parts:

FIG. 1 is a simplified block diagram of one exemplary embodiment of a system consistent with the present disclosure;

FIG. 2 shows a simplified block diagram of one exemplary embodiment of a transmitter consistent with the present disclosure.

FIG. 2A shows a simplified block diagram of another exemplary embodiment of a transmitter consistent with the present disclosure.

FIG. 3 shows waveforms associated with one exemplary embodiment of a transmitter consistent with the present disclosure.

FIG. 4 includes plots of Q-factor vs. power illustrating transmission performance of an embodiment consistent with the present disclosure.

FIG. 5 shows eye diagrams for the amplitude characteristic of an embodiment consistent with the present disclosure with varying amounts of symbol rate synchronous AM modulation.

FIG. 6 shows eye diagrams for the amplitude characteristic of an embodiment consistent with the present disclosure with varying amounts relative timing shift between the data and symbol rate synchronous AM modulation.

### DETAILED DESCRIPTION

In general, a system and method consistent with the present disclosure may include a multi-level data modulation format combined with amplitude, phase, and/or polarization modulation that is synchronous with the symbol rate. The amplitude, phase and/or polarization modulation that is combined with the multi-level modulation is referred to herein as “overhead modulation.” Using synchronous overhead modulation at the symbol rate with a multi-level modulation format consistent with the present disclosure yields high performance in long-distance high-speed optical transmission for both single channel and WDM optical transmission systems.

An optical wave of a certain center frequency in an optical fiber has three characteristics which may be made to vary continuously with time: amplitude, phase (frequency), and state of polarization. What is meant by “modulation format” is that one or more of these characteristics are made to vary in accordance with the information/data being imparted to that optical wave. The other parameters may not be constrained to follow the information signal. As used herein a “multi-level modulation format” shall refer to any modulation format that allows encoding of more than one data bit in each transmitted symbol. For example, DQPSK is a multi-level modulation format providing four symbol levels allowing encoding of two bits per symbol. Other multi-level modulation formats include, but are not limited to, QPSK, ASK-DBPSK, D8PSK, ASK-DQPSK, QASK-DQPSK.

The term “symbol” as used herein refers to the smallest unit of data transmitted at one time. The term “symbol-rate” as used herein refers to the number of symbols transmitted per-second, i.e. hertz (Hz). For data encoded using a multi-level modulation format multiple data bits are transmitted simultaneously in a single symbol, resulting in a symbol rate that is a fraction of the bit rate. For example, a DQPSK modulated signal includes two bits of data for each symbol, resulting in a symbol rate that is one-half of the bit rate.

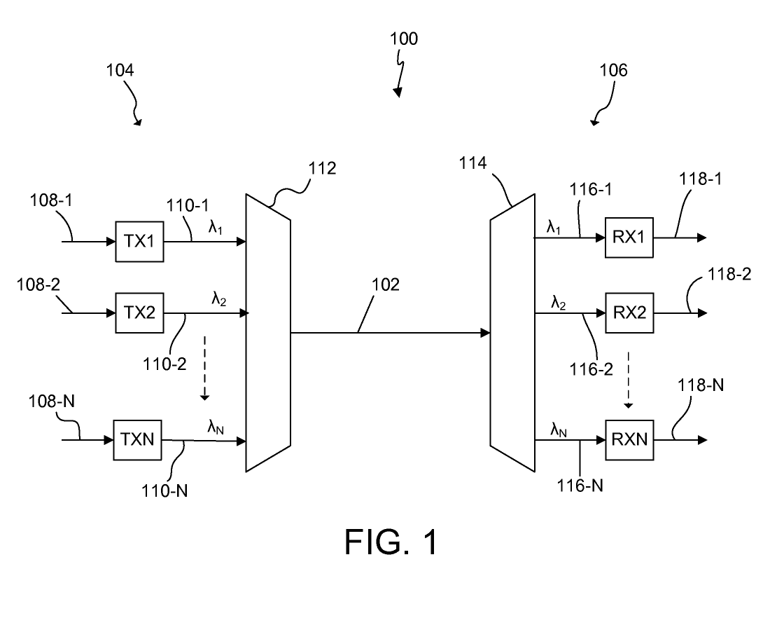

FIG. 1 is a simplified block diagram of one exemplary embodiment of a WDM transmission system 100 consistent with the present disclosure. The transmission system serves to transmit a plurality of optical channels over an optical information path 102 from a transmitting terminal 104 to one or more remotely located receiving terminals 106. The exemplary system 100 may be a long-haul submarine system configured for transmitting the channels from a transmitter to a receiver at a distance of 5,000 km, or more. Although exemplary embodiments are described in the context of an optical system, and are useful in connection with a long-haul WDM optical system, the broad concepts discussed herein may be implemented in other communication systems transmitting and receiving other types of signals.

Those skilled in the art will recognize that the system 100 has been depicted as a highly simplified point-to-point system for ease of explanation. For example, the transmitting terminal 104 and receiving terminal 106 may, of course, both be configured as transceivers, whereby each may be configured to perform both transmitting and receiving functions. For ease of explanation, however, the terminals are depicted and described herein with respect to only a transmitting or receiving function. It is to be understood that a system and method consistent with the disclosure may be incorporated into a wide variety of network components and configurations. The illustrated exemplary embodiments herein are provided only by way of explanation, not of limitation.

In the illustrated exemplary embodiment, each of a plurality of transmitters TX1, TX2 . . . TXN receives a data signal on an associated input port 108-1, 108-2 . . . 108-N, and transmits the data signal on associated wavelength λ₁, λ₂ . . . λ_{N}. One or more of the transmitters TX1, TX2 . . . TXN may be configured to modulate data on the associated wavelength with using a multi-level modulation format and with synchronous overhead modulation at the symbol rate. The transmitters, of course, are shown in highly simplified form for ease of explanation. Those skilled in the art will recognize that each transmitter may include electrical and optical components configured for transmitting the data signal at its associated wavelength with a desired amplitude and modulation.

The transmitted wavelengths or channels are respectively carried on a plurality of paths 110-1, 110-2 . . . 110-N. The data channels are combined into an aggregate signal on optical path 102 by a multiplexer or combiner 112. The optical information channel 102 may include optical fiber waveguides, optical amplifiers, optical filters, dispersion compensating modules, and other active and passive components.

The aggregate signal may be received at one or more remote receiving terminals 106. A demultiplexer 114 separates the transmitted channels at wavelengths λ₁, λ₂ . . . λ_{N} onto associated paths 116-1, 116-2 . . . 116-N coupled to associated receivers RX1, RX2 . . . RXN. One or more of the receivers RX1, RX2 . . . RXN may be configured to demodulate the transmitted signal and provide an associated output data signal on an associated output path 118-1, 118-2, 118-3, 118-N.

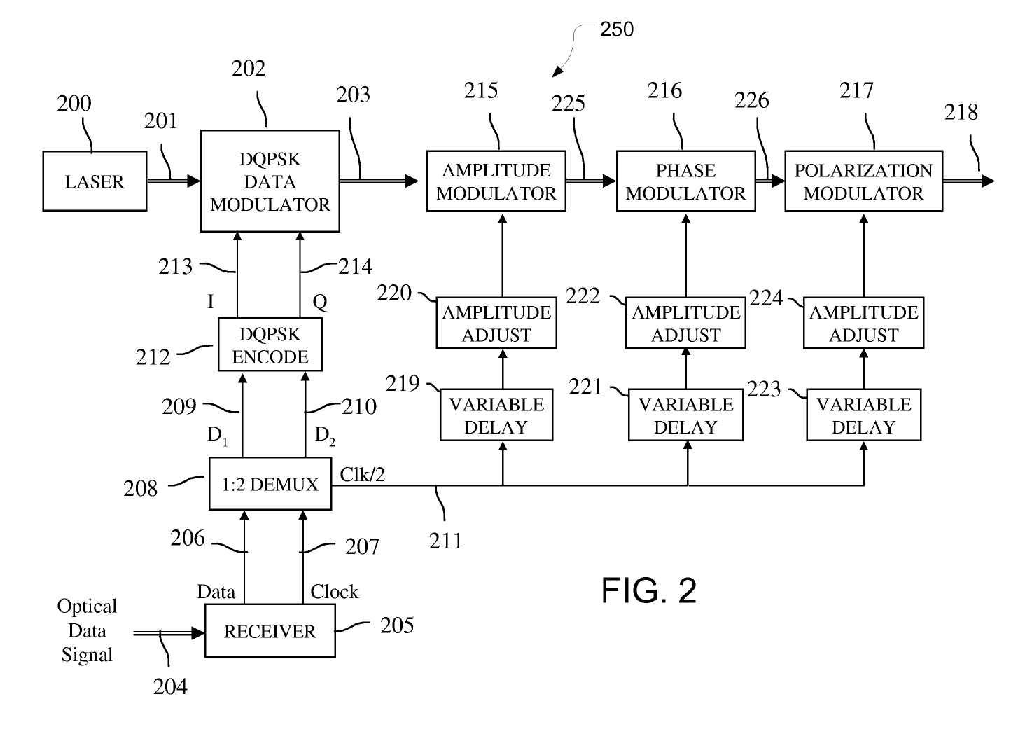

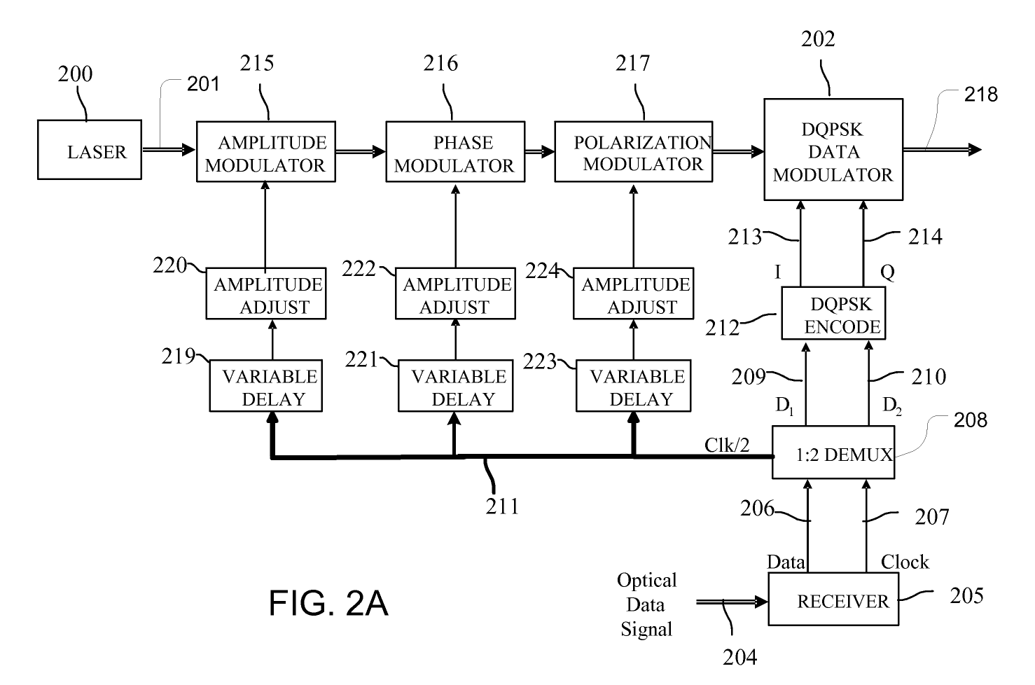

FIG. 2 is a simplified block diagram of one exemplary transmitter 250 consistent with the present disclosure. Although the illustrated exemplary embodiment includes a specific multi-level modulation format, i.e. DQPSK, and arrangement of modulators for imparting synchronous overhead modulation at the symbol rate, it is to be understood that the exemplary embodiments described herein are presented by way of illustration, not of limitation. A system consistent with the present disclosure may be implemented using any multi-level modulation format and/or arrangement of overhead modulation.

The illustrated exemplary embodiment 250 includes a laser 200 for producing a continuous wave (CW) optical signal 201. The optical signal may be coupled to a data modulator for encoding a data signal onto the optical signal 201 using a multi-level data modulation format. In the illustrated embodiment, for example, the optical signal 201 is coupled to a DQPSK data modulator 202 that modulates the signal according to a DQPSK modulation format to impart information thereto in a well known fashion, producing a modulated optical information signal 203. Using a DQPSK modulation format, the modulated optical information signal 203 may include two data bits per symbol.

The data modulator 202 may receive the data to be imparted to the optical signal 201 from an input data source 204 which may be a short-reach optical signal. The data received from the input data source may be modulated using a modulation format different from the multi-level data modulation format imparted by the modulator 202. The optical signal 204 may be converted to an electrical signal in optical receiver 205. The optical receiver 205 may provide electrical data and clock signals 206 and 207 to demultiplexer 208. Demultiplexer 208 may, for example, provide a bit de-interleaved signal on two lines 209 (D1) and 210 (D2), and a second clock signal 211 (Clk/2) at one-half the rate of the clock signal 207. Here two data signals 209 and 210 may be encoded using a known DQPSK encoder circuit 212 and the encoded signals may be output on the I and Q lines 213 and 214, which may drive the DQPSK modulator 202.

The resulting DQPSK signal 203 may go through one or more additional overhead modulation stages driven synchronously at the symbol rate. In the illustrated exemplary embodiment, the symbol rate is one-half of the clock rate, i.e. Clk/2. The overhead modulation stages may include an amplitude modulator 215, a phase modulator 216, and/or a polarization modulator 217 and yield a synchronously modulated (at the symbol rate) DQPSK signal 218. The modulation stage(s) may be driven with the symbol rate clock signal 211 (Clk/2) after the symbol rate clock signal passes through associated delay adjustments and amplitude adjustments. For example, the clock signal that drives amplitude modulator 215 may first go through delay element 219 and then amplitude adjustment 220. The clock signal that drives phase modulator 216 may first go through delay element 221 and then amplitude adjustment 222. The clock signal that drives polarization modulator 217 may first go through delay element 223 and then amplitude adjustment 224.

An exemplary manner in which the symbol rate clock 211 drives the amplitude modulator 215 may be described by examining the electric field components of the optical signal 203 on which the amplitude modulator acts. In x-y coordinates these components may be expressed as follows:

Eₓ(t)=Aₓ(t)e^{i(ωt+φ}^{ₓ}^{(t))} (1)

E_{y}(t)=A_{y}(t)e^{i(ωt+φ}^{_{y}}^{(t))} (2)

where ω is the optical carrier frequency, Aₓ(t) and A_{y}(t) are assumed to be real field amplitudes which could include any intensity modulation, and φₓ(t) and φ_{y}(t) are the optical phase components and includes the data modulation imparted by modulator 202 and any other optical phase modulation that might be present. The amplitude modulator 215 may modulate the optical signal by varying only the real amplitudes Aₓ(t) and A_{y}(t), with a function F(t) that is periodic and has a fundamental frequency component that is equal to, and phase locked to the clock signal 211. Modulator 215 may impress an additional amplitude modulation such that the intensity of signal 203 is multiplied by I(t). Here it is assumed that the periodic function F(t) is normalized to be in the range bounded by [+1,−1]. I(t) may be given by;

I(t)=0.5*[(1−B)F(t+Ψₐₘ)+1+B] (3)

$$B ≡ \frac{100 - {A}_{am}}{100 + {A}_{am}} \\ 0 \leq {A}_{am} \leq 100 \qquad ( 4 )$$

where Aₐₘ is the percentage of amplitude modulation placed on signal 203 by modulator 215, and Ψₐₘ is the phase angle of the modulation with respect to the data modulation. Thus, I(t) may be a scaled version of periodic function F(t) with a maximum value of unity, a minimum value of B, and is offset in time by Ψₐₘ. The AM level may be set by amplitude adjust 220, and the offset Ψₐₘ is adjusted by variable delay 219. The signal out of the amplitude modulator 225 may be represented by the following electric field components;

Eₓ₋ₒᵤₜ(t)=\sqrt{I(t)}Aₓ(t)e^{i(ωt+φ}^{ₓ}^{(t)} (5)

E_{y-out}(t)=\sqrt{I(t)}A_{y}(t)e^{i(ωt+φ}^{_{y}}^{(t)} (6)

The description of the additional modulation is provided general terms with any period function that fits the above description. However, a sinusoidal modulation may be particularly useful. Also, as is well known in the art the electrical signal driving amplitude modulator 215 may be a sinusoidal signal with a frequency at one-half the symbol rate, driven at twice the voltage (assuming that amplitude modulator 215 is a Mach-Zehnder interferometer type of modulator).

The means by which the phase modulator 216 and polarization modulator 217 operates on the signal may be similar to that of the amplitude modulator 215. These components may be operated in a manner as described in connection with equations (5) and (6) with the inclusion of additional phase terms. For example, the synchronous modulation at the symbol rate imparted by the modulators 216 and 217 may be sinusoidal. The modulation stages 216 and 217 may modify the optical phase of the signal 203 while the amplitude is unchanged. In this case the phase modulation imparted to the optical signal may include two separate and independent phases: a phase Ψ₂ associated with polarization modulator 217 and a phase Ψ₁ associated with the optical phase modulator 216. Thus, the phase angles φₓ and φ_{y} of the optical signal 218 launched from the polarization modulator may become:

φₓ(t)=aₓ cos(Ωt+Ψ₂)+b cos(Ωt+Ψ₁) (7)

φ_{y}(t)=a_{y} cos(Ωt+Ψ₂)+b cos(Ωt+Ψ₁) (8)

where aₓ and a_{y} are the phase modulation indices of the polarization modulator, b is the phase modulation index of the optical phase modulator, Ψ_{1,2} are the phase offsets set by delay elements 221 and 223, respectively, and Ω is the bit rate set by clock 211.

As equations (7) and (8) indicate, the optical phase modulator 216 may impart the same phase modulation to both the x and y components of the optical signal. Accordingly, the optical phase modulator 216 may modulate the optical phase of signal 203 without modulating its polarization. A reason the optical phase modulator 216 does not modulate the polarization may be that the polarization modulation of the optical signal is proportional to the difference between the phases φₓ and φ_{y} and this difference is unaffected by the optical phase modulator 216 since it modulates both φₓ and φ_{y} by equal amounts. In principle, every possible State-of-Polarization (SOP) of a monochromatic signal having these electric field components can be obtained by varying the ratio aₓ/a_{y} while maintaining the value of (aₓ²+a_{y}²) constant and varying the relative phase difference φₓ−φ_{y} between 0 and 2π. However, the polarization modulator 217 may serve to modulate the SOP of the optical signal by varying only the difference of the phases φₓ and φ_{y}, which is sufficient to provide a “degree of polarization” (DOP) whose average value over a modulation cycle is low.

Accordingly, the output signal 218 may have a degree of polarization that can be substantially equal to zero and is said to be polarization scrambled. The polarization modulator 217 may serve to trace the SOP of optical information signal 218 on a complete great circle of the Poincare sphere. Alternatively, the SOP of the optical signal may reciprocate along the Poincare sphere. In either case, the average value of the SOP over each modulation cycle may be substantially lowered from a value of unity.

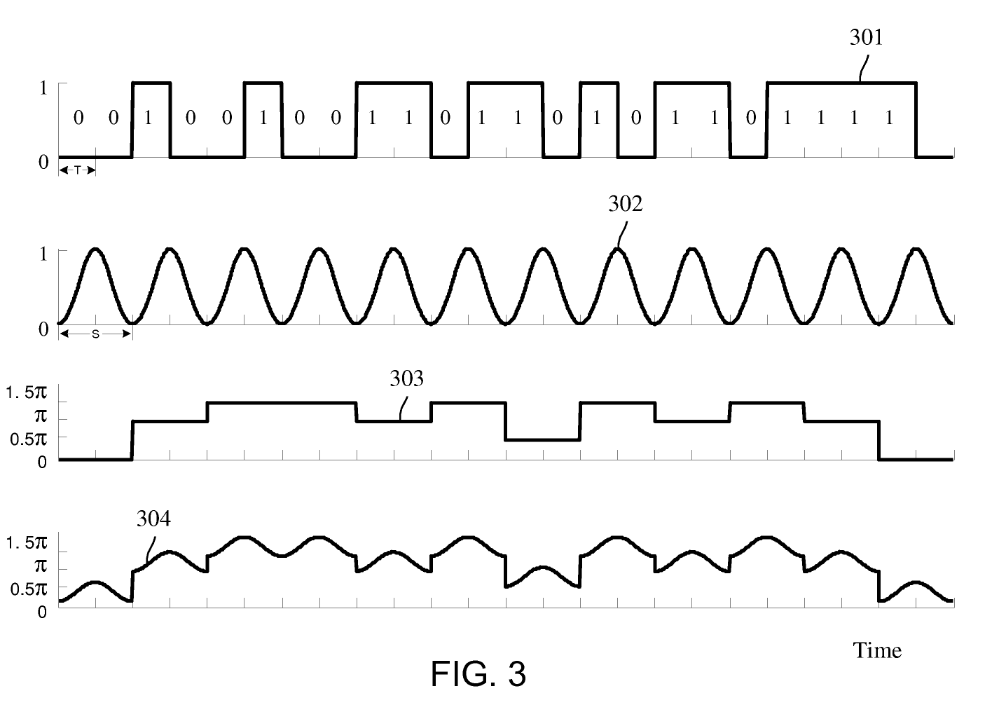

One of ordinary skill in the art will recognize that the functions of the various modulators are shown in FIG. 2 for purposes of illustration only and that two or more of the modulators may be realized in a single functional unit. For example, data modulator 202 may also function as the amplitude modulator 215 by having the data signals 213 and 214 provide the proper electrical drive signal. In addition, the functions of phase modulator 216 and polarization modulator 217 may be combined in a manner similar to that shown in FIG. 3 of U.S. Pat. No. 5,526,162, the teachings of which are incorporated herein by reference.

One of ordinary skill in the art will also recognize that the modulators may be provided in any order. As shown in FIG. 2A, for example, overhead modulation may be imparted before data modulation, i.e. the data modulator may be coupled to the output of the overhead modulator(s), or a portion of the overhead modulation may be provided before the data modulation with another portion of the overhead modulation imparted after the data modulation. Also, it may be useful to use only one or more of the described modulators. For example, in some applications polarization modulation might not be necessary and devices, 217, 224, and 223 might be omitted. Also, overhead modulation may be generated by electrical waveforms, e.g. through direct modulation of the laser. The expressions “communicates” and “coupled” as used herein refer to any connection, coupling, link or the like by which signals carried by one system element are imparted to the “communicating” or “coupled” element. Such “communicating” or “coupled” devices are not necessarily directly connected to one another and may be separated by intermediate optical components or devices.

FIG. 3 illustrates a series exemplary waveforms associated with a transmitter consistent with the present disclosure configured to transmit a CRZ-DQPSK waveform (i.e., synchronous amplitude and phase modulation, without the polarization modulation). Data pattern 301 may, for example, represent an optical data on signal 204 modulated according to a typical “short reach” format different from the multi-level modulation format imparted by the transmitter 250. The data bits in waveform 301 may appear at the input to a transmitter consistent with the present disclosure at a bit rate B (or equivalently a bit time T=1/B). This input data stream of pattern 301 may, for example, operate at a bit rate at 40 Gb/s, which would make the bit time T ˜25 psec. Waveforms 302 and 303 illustrate exemplary amplitude and phase of the signal at point 225 in FIG. 2. The amplitude characteristic 302 shows pulses that occupy about 40% of the symbol time S. These pulses were formed with amplitude modulator 215, where the amplitude modulation index (the modulation depth) is 100%. In this diagram the symbol time S is shown as being twice the bit time (2T) of the input data.

To improve system BER, one or more of the transmitters in a system consistent with the disclosure may include an encoder for applying forward error correction (FEC) coding to the modulated data. As is known to those of ordinary skill in the art, FEC coding essentially involves incorporation of a suitable code into a data stream for the detection and correction of data errors about which there is no previously known information. Error correcting codes are generated for a stream of data (i.e. encoding) and are sent to a receiver. The receiver may include an FEC decoder for recovering the error correcting codes and uses the codes to correct any errors in the received stream of data (i.e. decoding).

Numerous error correcting codes are known, each with different properties that are related to how the codes are generated and consequently how they perform. Some examples of these are the linear and cyclic Hamming codes, the cyclic Bose-Chaudhuri-Hocquenghem (BCH) codes, the convolutional (Viterbi) codes, the cyclic Golay and Fire codes, and some newer codes such as the Turbo convolutional and product codes (TCC, TPC). Hardware and software configurations for implementing various error correcting codes are known to those ordinary skill in the art. In a system consistent with the present disclosure, if a 7% FEC overhead was used, for example, the actual symbol rate would be increased by 7% and the corresponding symbol period would be decreased by 7%.

Waveform 303 shows the optical phase of the signal at point 225. Here the RZ-DQPSK signal takes on one of 4 values/levels separated by π/2 radians (i.e., 0, π/2, π, 3π/2). Waveform 304 shows the optical phase at point 226 in FIG. 2. A difference between waveforms 303 and 304 is the sinusoidal phase modulation provided by phase modulator 216. Waveform 304 shows a sinusoidal phase modulation with a peak-to-peak phase modulation of 1 radian. The phase of signal depicted in 304 is not a constant value over the symbol time, but the phase difference between contiguous bits is constant. Thus, a differential phase demodulator may still demodulate the signal without any “back-to-back” degradation penalty. This is described in U.S. Patent Publication No. 2004/0161245 by Neal S. Bergano entitled “Synchronous amplitude modulation for improved performance of optical transmission systems,” the teachings of which are fully incorporated herein by reference.

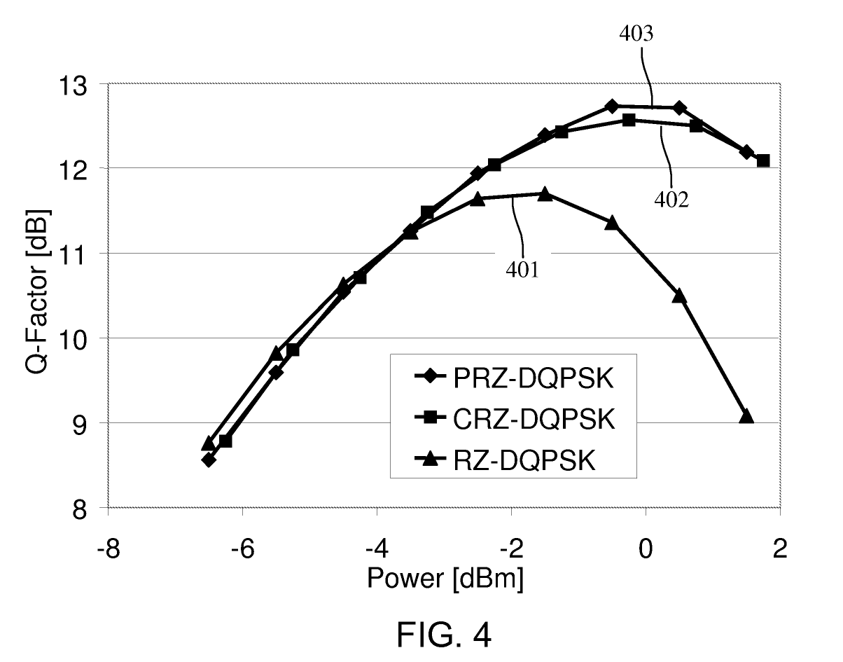

FIG. 4 illustrates an exemplary experimental verification that the a system consistent with the present disclosure may improve the nonlinear tolerance of an optical transmission system. The motivation for adding the extra modulation provided by amplitude modulator 215, phase modulator 216, and/or polarization modulator 217 is to improve the transmission performance in an optical data transmission system. This figure shows data collected for three different modulation formats that are possible using the exemplary transmitter shown in FIG. 2.

In this experiment twenty-eight WDM channels with 133 GHz channel spacing at a bit rate of 42.7 Gb/s were transmitted. The DQPSK modulator was driven by two 21.4 Gb/s pre-coded 2¹⁵−1 pseudo-random bit streams. Adjacent channels were randomly polarized (PRZ) or orthogonally polarized (CRZ) and modulated with inverted and delayed data patterns.

After dispersion pre-compensation, the WDM signals were launched into the circulating loop test bed at a transmission distance of 6,550 km. The 468 km loop test bed consisted of twelve single-stage C-band EDFAs, nine 45 km slope matched spans, and two 30 km compensating spans. The data was collected for 14 passes through the 468 km loop test bed, which makes the 6,550 km transmission distance. The slope matched spans were made of 27 km of large effective area fiber (100 μm², +20 ps/nm/km) followed by 18 km of inverse dispersion fiber (30 m², 40 ps/nm/km). The measured residual dispersion slope was 2 fs/nm̂2/km and the measured PMD of the test bed (including fibers, EDFAs, and all components) was 0.056 ps/sqrt(km).

In the receiver, after dispersion post-compensation, the measured channel was filtered and demodulated using 21.4 GHz Mach-Zehnder delay interferometers. The two optical outputs were sent to a balanced receiver.

Previous work has shown that synchronous modulation can be used to improve nonlinear tolerance at the expense of spectral efficiency (Neal S. Bergano et al.; Electronics Letters, vol. 32, no. 1, pp. 52-54, January 1996). Since the optical spectrum of DQPSK is about half that of DBPSK, significant spectral space (same spectral efficiency) is therefore available for synchronous modulation.

FIG. 4 shows the performance vs. channel power for PRZ-DQPSK, and CRZ-DQPSK, and RZ-DQPSK formats after 6,550 km. Both the synchronous polarization (PRZ) and phase modulation (CRZ) formats exhibited better nonlinear tolerance than the RZ-DQPSK alone due to lower optical spectral density. PRZ-DQPSK may have also benefited from fast polarization changes within each bit. The channel power tolerance was enhanced by ˜1.5 dB and the performance was improved by 1 dB compared to that of the RZ-DQPSK format.

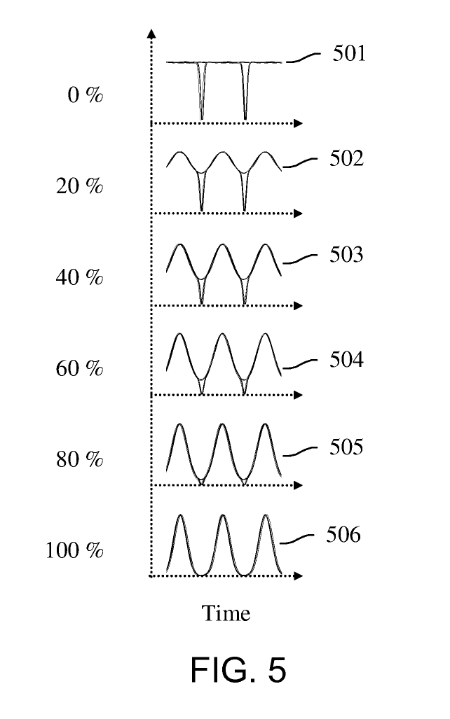

FIG. 5 shows the amplitude “eye diagram” at the output of an exemplary system consistent with the disclosure with different amplitude modulation levels/depths. The modulation indexes of both the amplitude modulator and the phase modulator may be adjustable (e.g. using amplitude adjustment means 220, 222, respectively) and could be used to optimize the transmission performance of a particular system design. For example, eye diagrams 501-506 corresponds to a depth of modulation varying from 0% (i.e., no synchronous amplitude modulation), 20%, 40%, 60%, 80%, and 100%. In some applications it may be advantageous to reduce the pulse width at the expense of greater optical bandwidth, while in others the correct engineering tradeoff might be the opposite. In a similar fashion, in some applications it might be advantageous to use a large phase modulation index in modulator 216, while in others it in others the correct engineering tradeoff might be the opposite.

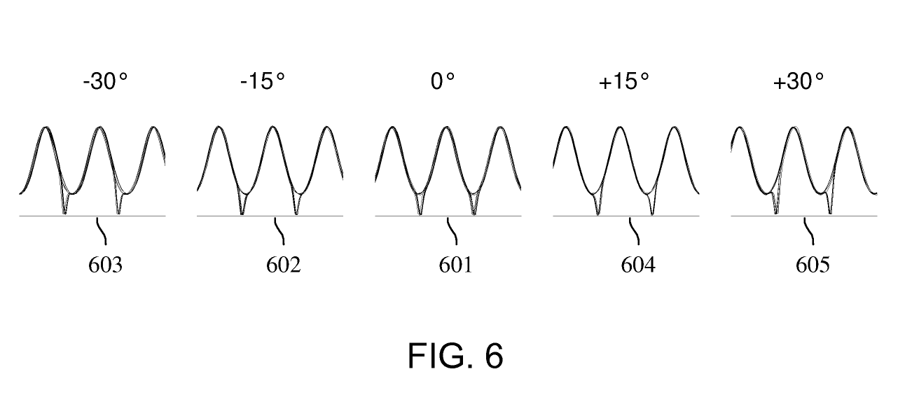

FIG. 6 shows the amplitude “eye diagram” at the output of a system consistent with the present disclosure with different delay settings (e.g. using variable delay means 219) between the data symbols and the synchronous amplitude modulation. All eye diagrams in FIG. 6 are shown for an AM index of 60%. Thus eye diagram 601, which is calculated for 0° timing offset and 60% AM modulation index, is similar to eye diagram 504. Eye diagram 602 and 603 are calculated for −15° and −30° respectively, while eye diagrams 604 and 605 are calculated for +15° and +30°. This adjustable “skew” could be used to improve the transmission performance.

Similar optimizations of drive and delay are also appropriate for the phase and polarization modulation sections. To achieve optimum performance all three synchronous modulations may be optimized together since the optimum modulation index for the amplitude modulator may change when used together with the phase modulation. The choice of receive optical filter may also be chosen optimally for the chosen modulation format.

In accordance with the present disclosure, a method and apparatus is provided that yields improved performance of long-distance high-speed optical transmission for both single channel and WDM by using synchronous overhead modulation combined with a multi-level transmission format. This overhead modulation can be a combination of amplitude modulation, phase modulation, and/or polarization modulation that is synchronous with the symbol rate.

For example, differential quadrature phase shift keying (DQPSK) can be used to send two bits per symbol. Using two bits per symbol can reduce some types of penalties that depend on the length of the symbol, such as PMD and chromatic dispersion related penalties. A high-speed data signal may be de-multiplexed and encoded onto two paths (commonly known as I and Q for the “in-phase” and “quadrature” components). The I and Q components may be used to modulate an optical signal using a DQPSK modulator. Onto this basic DQPSK signal may be added an overhead modulation that is synchronous to the symbol rate. The resulting signal is more tolerant to the distortions usually found in lightwave transmission systems, and thus can give superior transmission performance.

According to one aspect of the disclosure, there is thus provide an apparatus for transmitting an optical signal including: a data modulator configured to modulate data on an optical signal using a multi-level data modulation format to provide a data modulated signal including multiple bits of the data encoded in each of a plurality of output symbols provided at a symbol rate; and at least one overhead modulator configured to impart a periodic modulation at the symbol rate of at least one characteristic selected from the group consisting of: an amplitude of the optical signal, a phase of the optical signal and a polarization of the optical signal.

According to another aspect of the disclosure, there is provided a transmission system including: a transmitter, an optical transmission path coupled to the transmitter, and a receiver coupled to the optical transmission path. The transmitter may include: a data modulator configured to modulate data on an optical signal using a multi-level data modulation format to provide a data modulated signal including multiple bits of the data encoded in each of a plurality of output symbols provided at a symbol rate; and at least one overhead modulator configured to impart a periodic modulation at the symbol rate of at least one characteristic selected from the group consisting of: an amplitude of the optical signal, a phase of the optical signal and a polarization of the optical signal.

According to yet another aspect of the disclosure there is provided a method of modulating an optical signal for transmission on an optical communication system, the method including: modulating data on the optical signal using a multi-level modulation format to encode multiple bits of the data in each of a plurality of output symbols provided at a symbol rate; and imparting a periodic modulation at the symbol rate of at least one characteristic selected from the group consisting of: an amplitude of the optical signal, a phase of the optical signal and a polarization of the optical signal.

The embodiments that have been described herein but some of the several which utilize a system or method consistent with the present disclosure and are set forth herein by way of illustration but not of limitation. Many other embodiments, which will be readily apparent to those skilled in the art, may be made without departing materially from the spirit and scope of the disclosure.

What is claimed is:

1. An apparatus for transmitting an optical signal comprising:
a data modulator configured to modulate data on an optical signal using a multi-level data modulation format to provide a data modulated signal comprising multiple bits of said data encoded in each of a plurality of output symbols provided at a symbol rate; and
at least one overhead modulator configured to impart a periodic modulation at said symbol rate of at least one characteristic selected from the group consisting of: an amplitude of said optical signal, a phase of said optical signal and a polarization of said optical signal.

2. An apparatus according to claim 1, wherein said periodic modulation at said symbol rate comprises periodic modulation of at least two characteristics selected from the group consisting of: said amplitude of said optical signal, said phase of said optical signal and said polarization of said optical signal.

3. An apparatus according to claim 1, wherein said periodic modulation at said symbol rate comprises periodic modulation of each of said amplitude of said optical signal, said phase of said optical signal and said polarization of said optical signal.

4. An apparatus according to claim 1, said apparatus further comprising at least one amplitude adjustment mechanism for selectively varying a level of said periodic modulation.

5. An apparatus according to claim 1, said apparatus further comprising at least one variable delay mechanism for selectively varying the timing of said periodic modulation relative said output symbols.

6. An apparatus according to claim 1, wherein said multi-level data modulation format is a differential quadrature phase shift keying (DQPSK) modulation format.

7. An apparatus according to claim 1, wherein said multi-level data modulation format is a quadrature phase shift keying (QPSK) modulation format.

8. An apparatus according to claim 1, wherein said data modulated signal comprises forward error correction (FEC) coding

9. An apparatus according to claim 1, wherein said periodic modulation at said symbol rate is established by a clock coupled to said data modulator.

10. An apparatus according to claim 1, wherein said at least one overhead modulator is coupled to an output of said data modulator.

11. An apparatus according to claim 1, wherein said data modulator is coupled to an output of said at least one overhead modulator.

12. An apparatus according to claim 1, wherein said data is received by said apparatus in a modulation format different from said multi-level data modulation format.

13. A transmission system comprising:
a transmitter comprising:
a data modulator configured to modulate data on an optical signal using a multi-level data modulation format to provide a data modulated signal comprising multiple bits of said data encoded in each of a plurality of output symbols provided at a symbol rate; and
at least one overhead modulator configured to impart a periodic modulation at said symbol rate of at least one characteristic selected from the group consisting of: an amplitude of said optical signal, a phase of said optical signal and a polarization of said optical signal.
an optical transmission path coupled to said transmitter; and
a receiver coupled to the optical transmission path.

14. A system according to claim 13, wherein said periodic modulation at said symbol rate comprises periodic modulation of at least two characteristics selected from the group consisting of: said amplitude of said optical signal, said phase of said optical signal and said polarization of said optical signal.

15. A system according to claim 13, wherein said periodic modulation at said symbol rate comprises periodic modulation of each of said amplitude of said optical signal, said phase of said optical signal and said polarization of said optical signal.

16. A system according to claim 13, said apparatus further comprising at least one amplitude adjustment mechanism for selectively varying a level of said periodic modulation.

17. A system according to claim 13, said apparatus further comprising at least one variable delay mechanism for selectively varying the timing of said periodic modulation relative said output symbols.

18. A system according to claim 13, wherein said multi-level data modulation format is a differential quadrature phase shift keying (DQPSK) modulation format.

19. A system according to claim 13, wherein said multi-level data modulation format is a quadrature phase shift keying (QPSK) modulation format.

20. A system according to claim 13, wherein said data modulated signal comprises forward error correction (FEC) coding

21. A system according to claim 13, wherein said periodic modulation at said symbol rate is established by a clock coupled to said data modulator.

22. A system according to claim 13, wherein said at least one overhead modulator is coupled to an output of said data modulator.

23. A system according to claim 13, wherein said data modulator is coupled to an output of said at least one overhead modulator.

24. A system according to claim 13, wherein said data is received by said transmitter in a modulation format different from said multi-level data modulation format.

25. A method of modulating an optical signal for transmission on an optical communication system, said method comprising:
modulating data on said optical signal using a multi-level modulation format to encode multiple bits of said data in each of a plurality of output symbols provided at a symbol rate; and
imparting a periodic modulation at said symbol rate of at least one characteristic selected from the group consisting of: an amplitude of said optical signal, a phase of said optical signal and a polarization of said optical signal.

26. A method according to claim 25, said method further comprising selectively adjusting a level of said periodic modulation at said symbol rate.

27. A method according to claim 25, said method further comprising selectively varying the timing of said periodic modulation of said amplitude of said optical signal relative said output symbols.
